(19) United States
(12) Patent Application Publication
(10) Pub. No.: US 2007/0101591 A1
(43) Pub. Date: May 10, 2007

(54) Hand saw

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., Shanghai (CN)

(21) Appl. No.: 11/545,729

(22) Filed: Oct. 10, 2006

(30) Foreign Application Priority Data
Oct. 10, 2005 (CN) 200510030342.9

(51) Int. Cl. B23D 51/01

(52) U.S. Cl. 30/517

(57) ABSTRACT

A handsaw that can be used for fixed depth cutting and has a replaceable saw blade is provided. The handsaw can include a handle, a blade, a positioning device and a movable disc nut wherein the positioning device can be fixed on the handle via one or more fastening members. The positioning device can also seal the fastening members via another fastening member. A replaceable saw blade can be set inside the positioning device and can be connected to the handle via a movable disc nut. The handle can be fixed to the replaceable saw blade by one or more fastening members.

### CROSS REFERENCE TO RELATED APPLICATION

This application claims the benefit under 35 USC §119 of Chinese Patent Application having Serial No. 200510030342.9 filed on Oct. 10, 2005, which is incorporated by reference herein.

### BACKGROUND OF THE INVENTION

1. Field of the Invention

Embodiments of the present invention generally relate to a handsaw. More particularly, embodiments of the present invention relate to a handsaw with an optional replaceable blade that can be used in fixed depth cutting to saw wood or other articles.

2. Description of the Related Art

A conventional handsaw has a saw blade and a handle. The saw blade has at least one flange. The handle is slotted on one side. The flange and the slot correspond, matching in order, to realize a position fixation. An example of this handsaw is disclosed in German Patent No. 2931426 (1982). The problem of this handsaw is the instability and the difficulty of replacing the saw blade when cutting with a fixed cutting depth.

There is a need, therefore, for a handsaw in which fixed-depth cutting can be performed easily, and for a saw blade that is replaceable.

### SUMMARY OF THE INVENTION

In one or more embodiments, the handsaw can be used for fixed depth cutting and allows for the changing of the saw blade. In one or more embodiments, the handsaw includes a handle and a positioning device fixed on the handle via one or more handle fastening members, such as nuts, bolts, screws, jack catches, and seals. In one or more embodiments, a replaceable saw blade can be set in the positioning device and can be connected to the handle via a movable disc nut. In one or more embodiments, the handle can be fixed to the replaceable saw blade by one or more blade fastening members, such as nuts, bolts, screws, jack catches, and seals.

In one or more embodiments herein, one or more slots can be formed for positioning the one or more handle fastening members on the side of the replaceable saw blade closer to the handle. In one or more embodiments, one or more slots can be formed for positioning the one or more handle fastening members on one of the lateral sides of the replaceable saw blade, while the blade can be arranged on the other side. In one or more embodiments, one or more slots can be formed on the side of the handle closer to the blade fastening members. In one or more embodiments, one or more additional slots can be superimposed on other slots of the handle and/or other slots of the replaceable saw blade.

In one or more embodiments, the positioning device can include one or more belt-shaped plates. In one or more embodiments, the replaceable saw blade and the handle can be connected via fastening members. In one or more embodiments, the saw blade can be replaced very easily. In one or more embodiments, the length of the replaceable saw blade can be changed with the movable disc nut to realize a fixed-depth cutting objective. In one or more embodiments, the hand saw can be used for fixed-depth cutting and the saw blade can be replaced.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic illustration of a handsaw according to one or more embodiments described.

FIG. 2 shows a schematic illustration of the handsaw of FIG. 1 along line A-A according to one or more embodiments described.

FIG. 3 shows a schematic illustration of the handsaw of FIG. 2 along line B-B according to one or more embodiments described.

### DETAILED DESCRIPTION OF THE EMBODIMENT

A detailed description will now be provided. Each of the appended claims defines a separate invention, which for infringement purposes is recognized as including equivalents to the various elements or limitations specified in the claims. Depending on the context, all references below to the “handsaw” may in some cases refer to certain specific embodiments only. In other cases it will be recognized that references to the “handsaw” will refer to subject matter recited in one or more, but not necessarily all, of the claims. Each of the handsaws will now be described in greater detail below, including specific embodiments, versions and examples, but the handsaws are not limited to these embodiments, versions or examples, which are included to enable a person having ordinary skill in the art to make and use the handsaws, when the information in this patent is combined with available information and technology.

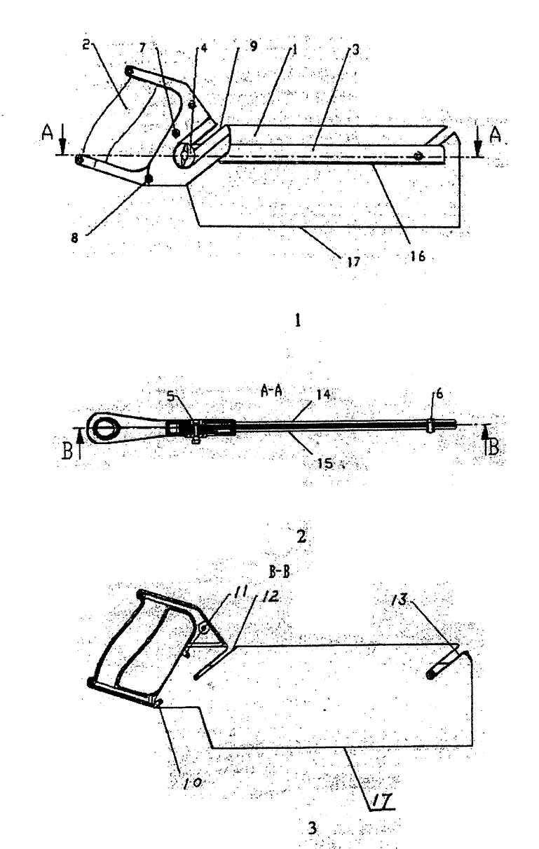

FIG. 1 shows a schematic illustration of a handsaw according to one or more embodiments described. FIG. 2 shows a schematic illustration of the handsaw of FIG. 1 along line A-A according to one or more embodiments described and FIG. 3 shows a schematic illustration of the handsaw of FIG. 2 along line B-B according to one or more embodiments described. In one or more embodiments, the handsaw includes a replaceable saw blade 1, a handle 2, a positioning device 3, and a movable disc nut 4. In one or more embodiments herein, the handsaw can further include slots 10 and 11 used for positioning fastening members 7 and 8. Slots 10 and 11 can be formed on the side of said replaceable saw blade 1 closer to handle 2 in the longitudinal direction. In one or more embodiments herein, additional slots 12 and 13 can be used for positioning fastening members 5 and 6. Slots 12 and 13 can be formed on one of the lateral sides of replaceable saw blade 1, while a blade 17 can be arranged on the other side. In one or more embodiments herein, another slot 12 can be superimposed with a primary slot 9 of the handle 2. In one or more embodiments herein, the primary slot 9 can be formed on the side of said handle 2 closer to fastening members 7 and 8. In one or more embodiments, the primary slot 9 can be superimposed with the slot 12 of replaceable saw blade 1.

Still referring to FIGS. 1 and 2, the positioning device 3 can include one or more belt-shaped plates 14, 15. Positioning device 3 can be fixed on handle 2 via fastening members first 5, 6, and 16. In one or more embodiments, the replaceable saw blade 1 can be arranged in the middle of positioning device 3 and can be connected to handle 2 via a movable disc nut 4. In one or more embodiments, the handle 2 can be fixed with replaceable saw blade 1 by fastening members 7 and 8.

Still referring to FIGS. 1, 2 and 3, to install the saw blade in one or more embodiments, saw blade 1 can be pushed into the narrow slot of handle 2. Slot 10 can be pushed into the corresponding fastening member 8. Saw blade 1 can be rotated along fastening member 8 so that slot 11 enters fastening member 7 and the primary slot 9 on handle 2 can be aligned with the slot 12 on saw blade 1. Positioning device 3 can be installed using fastening members 5 and 6 through slots 13 and 12 on replaceable saw blade 1 and the first slot 9 on handle 2. In one or more embodiments, positioning device 3 can include one or more belt-shaped plates 14, 15, which can be connected and fixed together by means of welding, adhesion, or screw threads. In one or more embodiments, there can be a defined space between the one or more belt-shaped plates 14, 15. Saw blade 1 can be rotated, and disc nut 4 can be moved along the primary slot 9 and the blade slot 12 based on the required depth. In one or more embodiment, all of the parts can be fixed, and disc nut 4 can be fastened. In one or more embodiments, disc nut 4 can be moved in order to disassemble replaceable saw blade 1 or adjust the depth of replaceable saw blade 1.

In one or more embodiments, when the saw is in operation, the wood or other object to be sawed can be fixed, and the user can push and pull the saw on the object.

In another embodiment, the present invention relates to:

1. A type of handsaw including a handle (2), characterized by the following facts: a positioning device (3) is fixed on the handle (2) via a first jack catch (5) and a second jack catch (6) and seals the first jack catch (5) and the second jack catch (6); a replaceable saw blade (1) is set in the middle of the positioning device (3) and is connected to the handle (2) via a movable disc nut (4); in the meantime, the handle (2) is fixed with the replaceable saw blade (1) by a third jack catch (7) and a fourth jack catch (8).

2. The handsaw of paragraph 1, wherein a second slot (10) and a third slot (11) used for positioning the third jack catch (7) and the fourth jack catch (8) are formed on the side of the aforementioned replaceable saw blade (1) in the longitudinal direction closer to the handle (2); a fourth slot (12) and a fifth slot used (13) for positioning the first jack catch (5) and the second jack catch (6) are formed on one of the lateral sides of the replaceable saw blade (1), while a blade (17) is arranged on the other side; the fourth slot (12) is superimposed with the first slot (9) of the handle (2).

3. The handsaw of paragraph 1 or 2, wherein the first slot (9) is formed on the side of the aforementioned handle (2) closer to the third jack catch (7) and the fourth jack catch (8); it is superimposed with the fourth slot (12) of the replaceable saw blade (1).

4. The handsaw of any of paragraphs 1 to 3, wherein the positioning device (3) comprises two belt-shaped plates (14, 15).

In another embodiment, the present invention relates to:

1. A handsaw comprising:

a handle;

a replaceable saw blade;

a positioning device; and

a movable disc nut;

wherein the positioning device is fixed on the handle via a first jack catch and a second jack catch and seals the first jack catch and the second jack catch via a seal.

2. The handsaw of paragraph 1, wherein the replaceable saw blade is set in the middle of the positioning device and is connected to the handle via the movable disc nut.

3. The handsaw of paragraphs 1 or 2, wherein the handle is fixed with the replaceable saw blade by a third jack catch and a fourth jack catch.

4. The handsaw of any of paragraphs 1 to 3, wherein a second slot and a third slot used for positioning the third jack catch and the fourth jack catch are formed on a side of the replaceable saw blade in the longitudinal direction close to the handle.

5. The handsaw of any of paragraphs 1 to 4, wherein a fourth slot and a fifth slot used for positioning the first jack catch and the second jack catch are formed on one of the lateral sides of the replaceable saw blade, while a blade is arranged on the other side.

6. The handsaw of any of paragraphs 1 to 5, wherein the fourth slot is superimposed with the first slot of the handle.

7. The handsaw of any of paragraphs 1 to 6, wherein the first slot is formed on a side of the handle close to the third jack catch and the fourth jack catch.

8. The handsaw of any of paragraphs 1 to 7, wherein the first slot is superimposed with the fourth slot of the replaceable saw blade.

9. The handsaw of any of paragraphs 1 to 8, wherein the positioning device comprises two or more belt-shaped plates.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A handsaw comprising:
a handle;
a replaceable saw blade;
a positioning device; and
a movable disc nut;
wherein the positioning device is fixed on the handle via a first jack catch and a second jack catch and seals the first jack catch and the second jack catch via a seal.

2. The handsaw of claim 1, wherein the replaceable saw blade is set in the middle of the positioning device and is connected to the handle via the movable disc nut.

3. The handsaw of claim 1, wherein the handle is fixed with the replaceable saw blade by a third jack catch and a fourth jack catch.

4. The handsaw of claim 1, wherein a second slot and a third slot used for positioning the third jack catch and the fourth jack catch are formed on a side of the replaceable saw blade in the longitudinal direction close to the handle.

5. The handsaw of claim 1, wherein a fourth slot and a fifth slot used for positioning the first jack catch and the second jack catch are formed on one of the lateral sides of the replaceable saw blade, while a blade is arranged on the other side.

6. The handsaw of claim 5, wherein the fourth slot is superimposed with the first slot of the handle.

7. The handsaw of claim 1, wherein the first slot is formed on a side of the handle close to the third jack catch and the fourth jack catch.

8. The handsaw of claim 7, wherein the first slot is superimposed with the fourth slot of the replaceable saw blade.

9. The handsaw of claim 1, wherein the positioning device comprises two belt-shaped plates.
